(19) United States
(12) Patent Application Publication
(10) Pub. No.: US 2026/0024790 A1
(43) Pub. Date: Jan. 22, 2026

(54) Fuel Cell System and Method of Controlling the Same

(71) Applicants: Hyundai Motor Company, Seoul (KR); Kia Corporation, Seoul (KR)

(72) Inventors: Jae Sung Ryu, Hwaseong-si (KR); Seung Man Park, Hwaseong-si (KR); Ji Hoon Ryu, Hwaseong-si (KR)

(21) Appl. No.: 18/965,742

(22) Filed: Dec. 2, 2024

(30) Foreign Application Priority Data
Jul. 17, 2024 (KR) 10-2024-0094491

(51) Int. Cl. H01M 8/04746; H01M 8/04223; H01M 8/0438; H01M 8/0444; H01M 8/04537

(52) U.S. Cl. CPC H01M 8/04753; H01M 8/04231; H01M 8/04388; H01M 8/04447; H01M 8/04559

(57) ABSTRACT

A fuel cell system and a method of controlling the same are disclosed. The fuel cell system includes a hydrogen pressure adjuster configured to adjust a hydrogen supply pressure of hydrogen supplied to a fuel cell stack, and a controller configured to determine whether or not a control mode for controlling the hydrogen supply pressure is required, based on a state of the fuel cell stack, and to control the hydrogen pressure adjuster to vary the hydrogen supply pressure in a predetermined pressure range based on a pressure increase rate or a pressure decrease rate, when the control mode is required.

### CROSS-REFERENCE TO THE RELATED APPLICATION

This application claims priority from Korean Patent Application No. 10-2024-0094491 filed on Jul. 17, 2024 in the Korean Intellectual Property Office, the disclosure of which is incorporated herein by reference in its entirety.

### TECHNICAL FIELD

The present disclosure relates to a fuel cell system and a method of controlling the same which are capable of inducing recirculation of hydrogen gas in an anode of a fuel cell stack.

### BACKGROUND

The matters described in this Background section are only for enhancement of understanding of the background of the disclosure, and should not be taken as acknowledgement that they correspond to prior art already known to those skilled in the art.

A fuel cell vehicle generally employs a fuel cell system comprising: a fuel cell stack configured to generate electrical energy via an electrochemical reaction of a fuel and an oxidant, thereby generating electric power; a fuel supplier configured to supply a fuel gas to an anode of the fuel cell stack via a fuel gas supply path; an air supplier configured to supply air containing oxygen to a cathode of the stack via an oxidation gas supply path; a heat manager configured to control an operating temperature of the fuel cell stack; and a controller configured to control an operation of the fuel cell system.

In such a fuel cell system, hydrogen (a fuel) is oxidized at the anode (oxidation electrode) of the fuel cell stack such that hydrogen ions and electrons are generated. The hydrogen ions from the anode move to the cathode (reduction electrode) while passing through an electrolyte membrane, and oxygen from air supplied to the cathode is reduced at the cathode, such that water is generated. After such an electrochemical reaction, gases such as hydrogen, oxygen crossing over from the cathode, nitrogen, etc., may remain at the anode of the stack. Such residual gases may cause hydrogen to be partially distributed at the anode without being uniformly distributed over the entirety of the anode. As a result, there may be a problem in that a deviation in hydrogen concentration is generated in the anode.

Recirculating hydrogen in/around the anode may help prevent such a hydrogen concentration deviation generated in the anode. For recirculation of hydrogen, a separate operation for generating a current or performing purging may be required or separate hardware such as a recirculation blower may be needed.

However, generating a current for inducing hydrogen recirculation may cause battery overcharging (e.g., due to generation of a current in an amount greater than a necessary amount given a particular operation condition of the fuel cell stack). On the other hand, purging for inducing hydrogen recirculation may reduce fuel economy of the fuel cell system. Furthermore, provision of separate hardware for either generating the current or purging may increase costs and complexities of the fuel cell system.

The above matters disclosed in this section are merely for enhancement of understanding of the general background of the disclosure and should not be taken as an acknowledgement or any form of suggestion that the matters form the related art already known to a person skilled in the art.

### SUMMARY

The following summary presents a simplified summary of certain features. The summary is not an extensive overview and is not intended to identify key or critical elements.

Systems, apparatuses, and methods are described for a folding structure of a mirror. A fuel cell system may comprise: a hydrogen pressure adjuster configured to adjust a hydrogen supply pressure of hydrogen supplied to a fuel cell stack; and a controller configured to: determine that a state of the fuel cell stack comprises a cell voltage deviation of the fuel cell stack satisfies a threshold, or the fuel cell stack is idle; and, based on the state of the fuel cell stack, control the hydrogen pressure adjuster to vary, based on a pressure increase rate or a pressure decrease rate, the hydrogen supply pressure within a pressure range.

Also, or alternatively, a fuel cell system may comprise: a fuel cell stack; a hydrogen pressure sensor configured to sense a hydrogen supply pressure of hydrogen supplied to the fuel cell stack; and a controller comprising at least one processor and at least one memory, wherein the controller is configured to: determine that a hydrogen pressure control condition associated with the fuel cell stack is satisfied, wherein the hydrogen pressure control condition comprises a cell voltage deviation of the fuel cell stack satisfying a threshold, and based on the hydrogen pressure control condition being satisfied, control the hydrogen supply pressure to be varied, based on a pressure increase rate or a pressure decrease rate, within a pressure range.

Also, or alternatively, a method of controlling a fuel cell system may comprise: determining that a state of a fuel cell stack of the fuel cell system comprises: a cell voltage deviation of the fuel cell stack satisfies a threshold; or the fuel cell stack is idle; and based on the determined state of the fuel cell stack, controlling a hydrogen supply pressure, to an anode of the fuel cell stack, to be varied, based on a pressure increase rate or a pressure decrease rate, within a pressure range. These and other features and advantages are described in greater detail below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram explaining a fuel cell system according to an example of the present disclosure;

FIG. 2 is a diagram illustratively depicting variation control of a hydrogen supply pressure;

FIG. 3 is a flowchart explaining a method of controlling the fuel cell system in accordance with an example of the present disclosure;

FIG. 4 is a flowchart explaining increase control of the hydrogen supply pressure in a controller according to another example of the present disclosure;

FIG. 5 is a flowchart explaining setting of a pressure increase rate and a pressure decrease rate according to an example of the present disclosure;

FIG. 6 and FIG. 7 are diagrams explaining setting of a first maximum pressure increase rate according to an example of the present disclosure;

FIG. 8 is a flowchart explaining setting of a second maximum pressure increase rate according to an example of the present disclosure; and

FIG. 9 is a flowchart explaining a fuel cell system control method according to another example of the present disclosure in the case in which sensing of oxygen concentration in the anode of the fuel cell stack is possible.

### DETAILED DESCRIPTION

In the following description, a detailed description of known functions and configurations incorporated herein will be omitted when such a detailed description may obscure the subject matter being described and is assumed known to one skilled in the art. In addition, the examples of the present disclosure will be more clearly understood from the accompanying drawings, but should not be limited by the accompanying drawings. It is to be appreciated that all changes, equivalents, and substitutes that do not depart from the spirit and technical scope of the present disclosure are encompassed in the present disclosure.

It will be understood that, although the terms “first”, “second”, etc., may be used herein to describe various elements, these elements should not be limited by these terms. These terms are only used to distinguish one element from another.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

Unless clearly used otherwise, singular expressions include a plural meaning.

In this specification, the term “comprising”, “including”, or the like, is intended to express the existence of the characteristic, the numeral, the step, the operation, the element, the part, or the combination thereof, and does not exclude another characteristic, numeral, step, operation, element, part, or any combination thereof, or any addition thereto.

In addition, the term “unit” or “control unit” used in specific terminology such as a fuel cell control unit (FCU) or the like is only a term widely used for designation of a controller for controlling a particular function of a vehicle and, as such, does not mean a generic functional unit.

The controller may include a communication device configured to communicate with another controller or a sensor for control of a function to be performed thereby, a memory configured to store an operating system, logic commands, input/output information, etc., and at least one processor configured to execute discrimination, calculation, determination, etc. required for control of the function to be performed.

Hereinafter, examples of the present disclosure will be described in detail with reference to the accompanying drawings, and the same or similar elements are designated by the same reference numerals regardless of the numerals in the drawings and redundant description thereof will be omitted.

The present disclosure is intended to induce recirculation of hydrogen in an anode of a fuel cell stack in order to solve a deviation in hydrogen concentration generated in the anode. In particular, the present disclosure is intended to induce recirculation of hydrogen in the anode through repeated adjustment of a hydrogen supply pressure of the fuel cell stack.

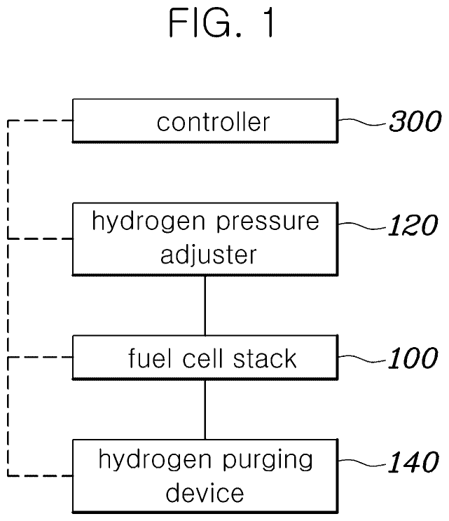

FIG. 1 is a block diagram explaining the fuel cell system according to an example of the present disclosure.

The fuel cell system may include a fuel cell stack 100, a hydrogen pressure adjuster 120, a hydrogen purging device 140, and a controller 300. FIG. 1 mainly shows constituent elements associated with the example of the present disclosure, and, in practical cases, the fuel cell system may be implemented to include a greater or smaller number of constituent elements than shown in FIG. 1.

The fuel cell system may comprise a plurality of sensors, such as temperature sensor, pressure sensors, level sensors, flow sensors, electrical circuit sensors, and/or proximity sensors. The electrical circuit sensors may comprise one or more voltage sensors, one or more current sensors, and/or one or more impedance sensors (e.g., an electrical resistance sensor). The electrical circuit sensors may measure a voltage deviation and or a voltage difference described herein (e.g., a difference between an average cell voltage and a minimum cell voltage of the fuel cell stack).

An anode and a cathode may be provided at the fuel cell stack 100, and the hydrogen pressure adjuster 120 and the hydrogen purging device 140 may be connected to the side of the anode of the fuel cell stack 100. The hydrogen pressure adjuster 120 may be provided in a form of a valve, which can control the hydrogen pressure supplied to the fuel cell stack 100 by controlling an opening angle of the valve. For example, the opening angle of the valve may be controlled by duty control. In an example, the hydrogen pressure adjuster 120 may include a hydrogen pressure control valve (e.g., or any other hydrogen pressure controller, hydrogen inlet/outlet controller, etc.) to adjust the hydrogen pressure.

The hydrogen pressure adjuster 120 may be provided at an anode input of the fuel cell stack 100. The hydrogen pressure adjuster 120 may be configured to adjust a pressure of hydrogen supplied to the anode of the fuel cell stack 100.

The controller 300 may determine whether or not a control mode for control of a hydrogen supply pressure supplied to the fuel cell stack 100 is required to induce recirculation of hydrogen in the anode of the fuel cell stack 100 (e.g., for accomplishment of the object of the present disclosure, such as uniformly distributing hydrogen at the anode). For example, the controller 300 may determine whether or not the above-described control mode is required (e.g., based on at least one of a cell voltage state of the fuel cell stack 100 or an operation state of the fuel cell stack 100).

Determining the cell voltage state of the fuel cell stack 100 may mean/comprise determining the cell voltage state of the fuel cell stack 100 based on an average cell voltage and/or a minimum cell voltage difference (referred to as a “cell deviation DV” hereinafter) of the fuel cell stack 100. The cell deviation DV may derived based on respective voltages of a plurality of cells included in the fuel cell stack 100 (e.g., based on measuring/determining the respective voltages). In addition, the operation state of the fuel cell stack 100 may mean an idle state, a start state, or a shut-down state of the fuel cell stack 100, without being limited thereto.

The controller 300 may determine that the above-described control mode is required based on the cell deviation DV being determined to be more than a predetermined first reference difference value (e.g., first threshold value), based on results of comparison therebetween and/or based on the operation state of the fuel cell stack 100 being an idle state. Here, the first reference difference value may mean a value set with reference to a maximum voltage deviation, which may be determined taking into consideration operation stability of the fuel cell stack 100.

For example, if hydrogen is non-uniformly distributed in the anode of the fuel cell stack 100, different cells of the stack may correspond to different amounts of hydrogen. A voltage value of a cell corresponding to shortage of hydrogen measured relative to those of other cells and, as such, a great cell deviation DV may be generated. Also, or alternatively, if the fuel cell stack 100 is in an idle state, this state corresponds to a bad operation condition in which circulation is not performed in the anode and, as such, it is more likely that an unbalance of hydrogen concentration or generation of oxygen at the side of the anode at different fuel cell locations occur.

Therefore, recirculation of hydrogen in the anode of the fuel cell stack 100 is determined based on the cell deviation or the idle state of the fuel cell stack 100. The above-described control mode is selectively performed based on results of the determination.

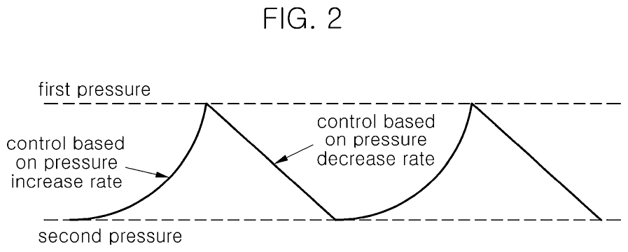

Upon determining that the control mode is required, the controller 300 may control a hydrogen supply pressure. For example, the controller 300 may control the hydrogen supply pressure (e.g., a pressure of hydrogen supplied to the anode) by controlling/using the hydrogen pressure adjuster 120 (e.g., a hydrogen pressure valve or the like). For example, as shown in FIG. 2, the controller 300 may variably control the hydrogen supply pressure in a predetermined pressure range based on a predetermined pressure increase rate or a predetermined pressure decrease rate. FIG. 2 is a diagram illustratively depicting variation control of a hydrogen supply pressure.

Here, the predetermined pressure range may mean a range set by a first pressure which is a maximum value (an upper limit value) and a second pressure which is a minimum value (a lower limit value). In an example, the second pressure may mean a value corresponding to a minimum pressure condition among operation conditions of the fuel cell stack 100, and the first pressure may mean a value obtained by adding, to the second pressure, a reference pressure difference capable of inducing an effect of recirculation of hydrogen in the fuel cell stack 100. These specific examples of second pressure and first pressure are only illustrative and the present disclosure is not limited thereto.

Upon determining to operate by the control mode, the controller 300 may determine a hydrogen supply pressure. This determination may be achieved based on sensing information from a hydrogen pressure sensor of or associated with the fuel cell system. The hydrogen supply pressure may be a target pressure corresponding to a target to be pursued. The controller 300 may determine the hydrogen supply pressure based on the sensing information received from the hydrogen pressure sensor. If the determined hydrogen supply pressure is less than the first pressure (e.g., a maximum value of the pressure range), the controller 300 may control the hydrogen supply pressure to increase (e.g., to the first pressure). The controller 300 may control the hydrogen supply pressure to increase based on the predetermined pressure increase rate. If the determined hydrogen supply pressure is not less than the first pressure (e.g., equal to or greater than the first pressure), the controller 300 may control the hydrogen supply pressure to decrease (e.g., to the second pressure). The controller 300 may control the hydrogen supply pressure to decrease based on the predetermined pressure decrease rate.

Also, or alternatively, if the hydrogen supply pressure reaches the second pressure (e.g., based on the decreasing), the controller 300 may again control the hydrogen supply pressure to increase to the first pressure, based on the pressure increase rate. That is, the controller 300 according to the example of the present disclosure may be configured to variably control (increase-control and/or decrease-control) the hydrogen supply pressure in the predetermined pressure range in order to induce recirculation of hydrogen in the anode of the fuel cell stack 100, thereby preventing generation of a hydrogen concentration deviation in the anode (e.g., uniformly distributing the hydrogen in the anode).

The controller 300 may be a fuel cell control unit (FCU) configured to control the fuel cell system. This is only illustrative and the present disclosure is not limited thereto. For example, the controller 300 may be implemented as a controller separate from the fuel cell controller and/or may be implemented in the form of two or more different controllers, respectively having distributed functions.

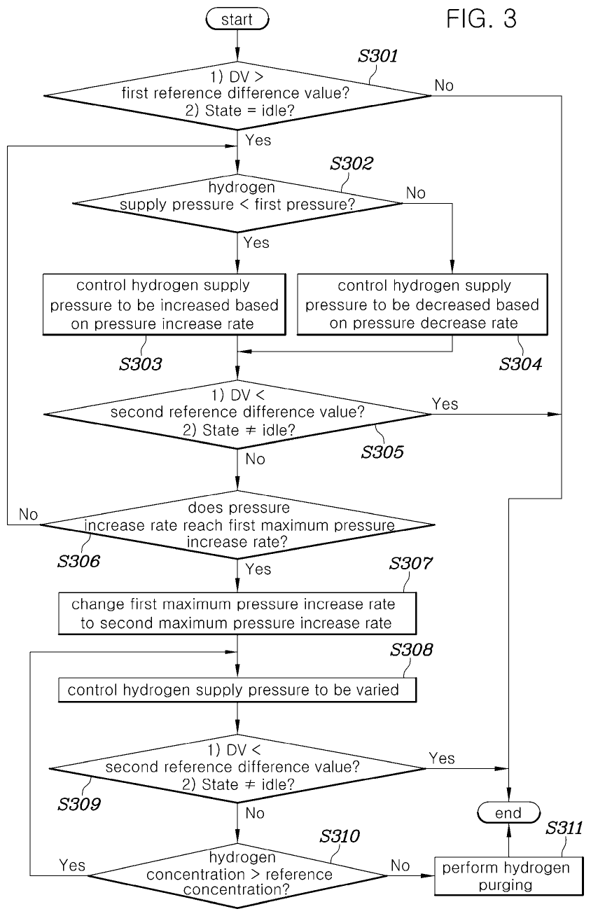

Hereinafter, a method of controlling the fuel cell system via the controller 300 in accordance with an example of the present disclosure will be described with reference to FIG. 3.

FIG. 3 is a flowchart explaining the method of controlling the fuel cell system in accordance with the example of the present disclosure. For convenience, FIG. 3 is described by way of an example in which the steps are performed by a processor circuit. One, some, or all steps of the example method of FIG. 3, or portions thereof, may be performed by one or more other circuits. For ease of explanation, the steps of the method in FIG. 3 is discussed as performed by the controller 300. One or some, steps of the example method of FIG. 3 may be omitted, performed in other orders, and/or otherwise modified, and/or one or more additional steps may be added.

Referring to FIG. 3, the controller 300 may determine that the control mode for controlling a hydrogen supply pressure is required (S301). For example, the determination may to control the hydrogen supply pressure based on the difference between the average cell voltage and the minimum cell voltage of the fuel cell stack 100 (the cell deviation DV) being satisfying (e.g., being greater than) the predetermined first reference difference value or based on the fuel cell stack 100 being in the idle state (“Yes” in S301). For example, the controller 300 according to the example of the present disclosure may determine whether or not the cell deviation DV of the fuel cell state 100 is more than the first reference difference value and/or whether or not the fuel cell stack 100 is in the idle state, and may then determine that the control mode is required, if at least one of the two conditions is satisfied.

Upon determining that the control mode is required, the controller 300 may identify/determine the hydrogen supply pressure currently supplied to the fuel cell stack 100 (S302). If the hydrogen supply pressure is less than the first pressure (e.g., a maximum value of the predetermined pressure range) (“Yes” in S302), the controller 300 may control the hydrogen supply pressure to increase to the first pressure, based on a predetermined pressure increase rate (S303). If the hydrogen supply pressure is not less than the first pressure (“No” in S302), the controller 300 may control the hydrogen supply pressure to decrease to the second pressure (e.g., a minimum value of the pressure range) based on a predetermined pressure decrease rate (S304).

The controller 300 may control the hydrogen supply pressure to increase or to decrease, based on results of comparison between the hydrogen supply pressure and the first pressure (e.g., the maximum value of the pressure range) (S303 and S304).

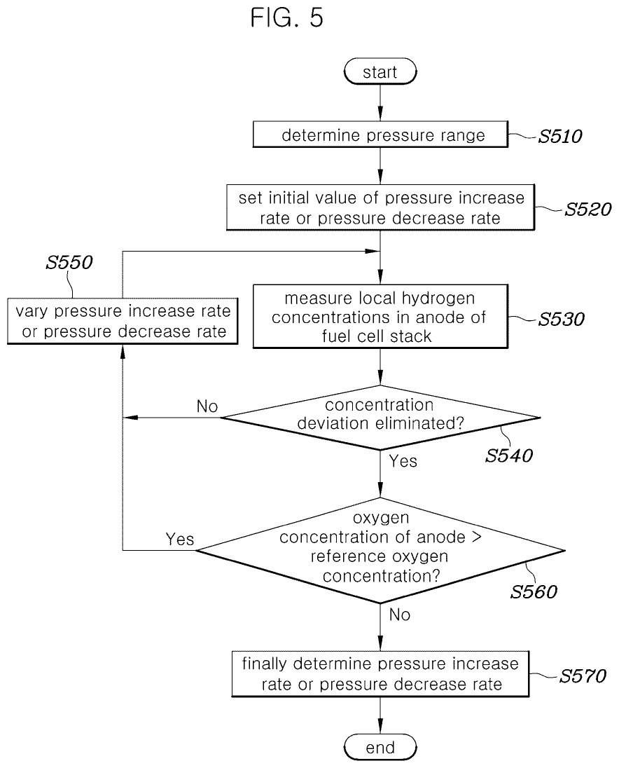

Before description of a subsequent control procedure, the predetermined pressure increase rate and the predetermined pressure decrease rate applied upon control of the hydrogen supply pressure in accordance with the example of the present disclosure will be described with reference to FIG. 5.

FIG. 5 is a flowchart explaining setting of the pressure increase rate and the pressure decrease rate according to an example of the present disclosure.

The controller 300 may determine a pressure range as a reference for variation control of the hydrogen supply pressure (S510). For example, the first pressure (e.g., the maximum value) and the second pressure (e.g., the minimum value) may be determined, the pressure range may be determined based on the first pressure and the second pressure. The controller 300 may set an initial value of the pressure increase rate or the pressure decrease rate in order to variably control the hydrogen supply pressure in accordance with the determined pressure range (S520). In an example, the initial value may be set for the hydrogen supply system so that the hydrogen supply system can be operated based on the initial hydrogen supply pressure.

Based on the initial value(s) of the pressure increase rate and/or the pressure decrease rate being set, the controller 300 may variably control the hydrogen supply pressure based on the set initial value(s) and may then measure local hydrogen concentrations in the anode of the fuel cell stack 100 (S530). Based on the measured local hydrogen concentrations, the controller 300 may check whether or not hydrogen recirculation occurs (e.g., sufficiently) in the anode (S540).

The controller 300 may determine whether or not a concentration deviation in the anode is eliminated (e.g., sufficiently reduced) based on the measured hydrogen concentrations (S540). If the concentration deviation has not been eliminated (“No” in S540), the hydrogen recirculation is insufficient. In this case, the controller 300 may repeat variation control of the hydrogen supply pressure with an adjusted pressure increase rate and/or adjusted pressure decrease rate (S550) and repeat steps S530-S540 until the concentration deviation in the anode is eliminated (sufficiently reduced) (“Yes” in step S540).

If hydrogen is excessively introduced (e.g., due to an excessive pressure increase rate and/or insufficient pressure decrease rate) during variation control of the hydrogen supply pressure, oxygen may be generated in the anode due to a concentration gradient difference between the anode and the cathode of the fuel cell stack 100. To this end, even if the concentration deviation in the anode has been eliminated (“Yes” in S540), the controller 300 may further check whether or not the oxygen concentration of the anode of the fuel cell stack 100 is more than a reference oxygen concentration (S560).

The controller 300 may check whether the oxygen concentration of the anode of the fuel cell stack 100 is more than the reference oxygen concentration (S560). If the oxygen concentration of the anode is more than the reference oxygen concentration (“Yes” in S560), it may be necessary to decrease the oxygen concentration of the anode of the fuel cell stack 100 (e.g., to not be more than the reference oxygen concentration) via recirculation of hydrogen. If the oxygen concentration of the anode does not satisfy (is more than) the reference oxygen centration (“Yes” in S560), the controller 300 may variably control the hydrogen supply pressure by varying the pressure increase rate or the pressure decrease rate (S550).

If the concentration deviation in the anode of the fuel cell stack 100 has been eliminated (e.g., sufficiently reduced) (“Yes” in S540), and the oxygen concentration of the anode of the fuel cell stack 100 satisfies (e.g., is not more than) the reference oxygen concentration (“No” in S560), the controller 300 may determine a currently set pressure increase rate as the predetermined pressure increase rate and/or a currently set pressure decrease rate as the predetermined pressure decrease rate (S570). The determined predetermined pressure increase rate and the predetermined pressure rate satisfying the above-described conditions (e.g., sufficiently reduce hydrogen nonuniformity without increasing oxygen concentration at the anode excessively). The controller 300 may perform variation control of the hydrogen supply pressure according to the example of the present disclosure while reflecting the finally-determined pressure increase rate or pressure decrease rate.

The variation control of the hydrogen supply pressure described with reference to FIG. 5 has been described in conjunction with the case in which variation control of the hydrogen supply pressure is performed based on the finally-determined pressure increase rate or pressure decrease rate, that is, a pressure increase rate or a pressure decrease rate which is a single fixed value.

In some cases, variation control of the hydrogen supply pressure based on a pressure increase rate or a pressure decrease rate fixed to a single value may induce hydrogen recirculation in the fuel cell stack 100 in an initial stage of variation control, but there may be less effective in inducing continuous hydrogen recirculation at later stages (e.g., as the pressure approaches the first pressure when increasing or the second pressure when decreasing).

To this end, referring again to FIG. 3, the controller 300 according to the example of the present disclosure may perform variation control of the hydrogen supply pressure using a pressure increase rate or decrease rate that varies (e.g., continuously, stepwise, etc.) with current pressure (e.g., without using a fixed value of the pressure increase rate or the pressure decrease rate over the pressure range).

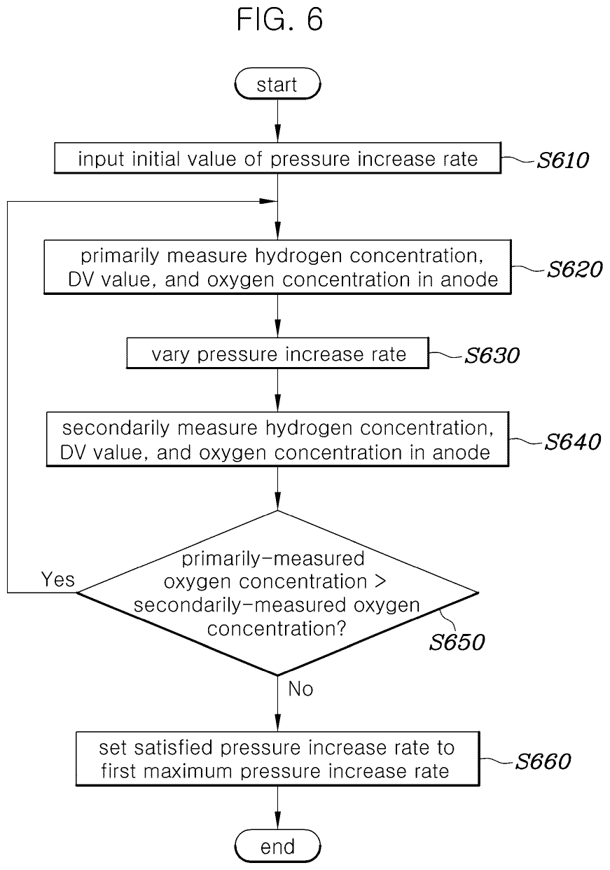

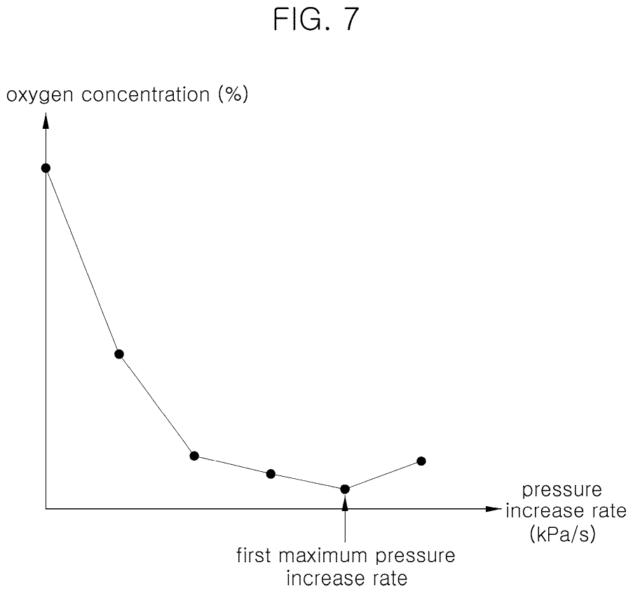

For example, in association with increase control of the hydrogen supply pressure, the controller 300 may control the hydrogen supply pressure to increase based on the predetermined pressure increase rate (S303). For example, the controller 300 may control the hydrogen supply pressure to increase to the first pressure while gradually varying the pressure increase rate until the pressure increase rate reaches a predetermined first maximum pressure increase rate (e.g., as a nonlimiting example, the pressure increase rate in FIG. 2 continuously increases). Here, the predetermined first maximum pressure increase rate may mean a pressure increase rate preventing oxygen from crossing over to the side of the anode due to a concentration gradient difference between the anode and the cathode of the fuel cell stack 100 while inducing recirculation of hydrogen in the anode. The first maximum pressure increase rate may be derived via experiments/calibration and may then be set. The first maximum pressure increase rate set through experiments/calibration will be described with reference to FIGS. 6 and 7.

FIG. 6 and FIG. 7 are diagrams explaining setting of the first maximum pressure increase rate according to an example of the present disclosure.

The procedure, which will be described with reference to FIG. 6 and FIG. 7, may be a procedure experimentally performed in an ideal state for a system configured identically to the fuel cell system according to the example of the present disclosure.

Referring to FIG. 6, an initial value of the pressure increase rate may be input to the controller 300 (S610). For example, the initial value of the pressure increase rate may be 0 kPa/s. This initial increase rate is only illustrative and the present disclosure is not limited thereto.

The controller 300 may measure a first hydrogen concentration in the anode of the fuel cell stack 100, a first cell deviation DV, and/or a first oxygen concentration in the anode based on the initial value of the pressure increase rate (e.g., while the pressure is increasing at the initial value of the pressure increase rate) in a state in which the pressure increase rate does not vary (S620). After the first measurement(s) (e.g., at the initial value of the pressure increase rate), the controller 300 may vary the pressure increase rate (S630), and may then perform control to increase a hydrogen supply pressure based on (e.g., at) the varied pressure increase rate. For example, the pressure increase rate variation according to the example of the present disclosure may mean a gradual increase in pressure increase rate, but this is only illustrative and the present disclosure is not limited thereto.

The controller 300 may again measure a second hydrogen concentration in the anode of the fuel cell stack 100, a second cell deviation DV, and/or a second oxygen concentration in the anode in a state in which the pressure increase rate varies (e.g., at the varied pressure increased rate) (S640).

The controller 300 may compare the first measured oxygen concentration and the second measured oxygen concentration with each other (S650). If the first measured oxygen concentration is greater than the second measured oxygen concentration (“No” at S650) the first pressure increase rate may be set to the first maximum pressure increase rate S660). If the first measured oxygen concentration is not greater than the second measured oxygen concentration (“Yes” at S650), the controller 300 may then repeatedly execute steps S620 to S650 using the varied pressure increase rate as the first pressure increase rate until the first measured oxygen concentration before the varied pressure increase rate is not more than the second measured oxygen concentration after the pressure increase rate varies for a given iteration of $650.

FIG. 7 is a graph depicting a variation in the oxygen concentration in the anode of the fuel cell stack 100 based on a variation in pressure increase rate.

Referring to FIG. 7, it may be seen that the oxygen concentration in the anode of the fuel cell stack 100 becomes excessive when the pressure increase rate has an initial value of 0 kPa/s (e.g., without varying from the initial value). It may also be seen that the oxygen concentration in the anode exhibits a tendency toward gradual decrease as the pressure increase rate is subsequently varied (for example, increased), and then again exhibits a tendency toward increase after a particular pressure increase rate (e.g., there is a pressure increase rate that appears to minimize the oxygen concentration). The reason why the oxygen concentration again increases after the particular time may be that, without being limited by any theory, when hydrogen is excessively supplied for hydrogen recirculation in the anode, a concentration gradient difference (concentration unbalance) occurs between the anode and the cathode of the fuel cell stack 100 and, as such, oxygen at the side of the cathode crosses over to the side of the anode. If oxygen again crosses over to the side of the anode, it may be difficult for hydrogen recirculation in the anode to be effectively carried out, due to the oxygen accumulated in the anode. It may be possible to derive an optimum pressure increase rate capable of achieving only hydrogen recirculation in the anode of the fuel cell stack 100 by comparing oxygen concentrations before and after the pressure increase rate varies, taking into consideration the above-described situation.

Again referring to FIG. 6, if the first measured oxygen concentration is not more than the second measured oxygen concentration (“No” in S650), through repeated execution of steps S620 to S650, the controller 300 may set the pressure increase rate to be the rate before variation that satisfies the above-described condition (e.g., the rate corresponding to the first measured oxygen concentration that is not greater than the second measured oxygen concentration) to a first maximum pressure increase rate (S660). For example, although the first maximum pressure increase rate according to the example of the present disclosure, which is obtained when the procedure of FIG. 6 is experimentally performed, may be 4 kPa/s, this is only illustrative and the present disclosure is not limited thereto.

In another example, the controller 300 may separately determine the first measured oxygen concentration and the second measured oxygen concentration, and may then determine whether or not the second measured oxygen concentration has a value approximate to 0% (e.g., about 0%), based on it being determined in step S650 that the first measured oxygen concentration is not more than the second measured oxygen concentration (“No” in S650). The controller 300 may repeatedly execute steps S620 to S650 until the second measured oxygen concentration has a value approximate to 0. In this case, when the first measured oxygen concentration (e.g., measured before the pressure increase rate varies) is not more than the second measured oxygen concentration secondarily (e.g., measured after the pressure increase rate varies) (“No” in S650), and the secondarily-measured oxygen concentration has a value approximate to 0, the controller 300 may set the pressure increase rate, which satisfies the above-described conditions, to the first maximum pressure increase rate (S660).

In another example, if the first measured oxygen concentration is not more than the second measured oxygen concentration (“No” in S650), the controller 300 may measure an oxygen concentration in the anode of the fuel cell stack 100 while varying the pressure increase rate to be gradually decreased, and may compare the measured oxygen concentrations with each other (e.g., periodically compare measured oxygen concentrations at the gradually decreasing pressure increase rate). In this case, in step S630 described above, the controller 300 may vary the pressure increase rate to be decreased in a range narrower than a range in which the pressure increase rate was varied to be increased to a varied pressure increase rate at which the second measured oxygen concentration was acquired. If the pressure increase rate is varied to be decreased following an initial increase, the controller 300 may compare the first measured oxygen concentration (e.g., measured before the pressure increase rate was increased at S630) and the second measured oxygen concentrations (e.g., measured after the pressure increase rate was varied to increase and then at as the pressure increase rate is subsequently decreased), and may vary the pressure increase rate to be decreased from the initial increase until the primarily-measured oxygen concentration is not more than the secondarily-measured oxygen concentration. In other words, if the first measured oxygen concentration (e.g., measured before the pressure increase rate was varied at S630) is not more than a given second measured oxygen concentration (e.g., measured after the pressure increase rate was varied) (“No” in S650), under the condition that the pressure increase rate varies to be increased through steps S620 to S650, the controller 300 may again vary the pressure increase rate, which satisfies the above-described condition, to be decreased, and may then set, to the first maximum pressure increase rate, a pressure increase rate satisfying the condition that the first measured oxygen concentration primarily (e.g., measured before the pressure increase rate was varied to be decreased) is not more than an second measured oxygen concentration (e.g., measured after the pressure increase rate was varied to be decreased) (S660).

Returning to step S303 in FIG. 3, the pressure increase rate according to the example of the present disclosure may mean a pressure increase speed (e.g., pressure/time such as kPa/s). Upon varying the pressure increase rate, the controller 300 may gradually vary the pressure increase rate based on a predetermined first pressure increase acceleration. For example, the controller 300 may uniformly gradually vary the pressure increase rate (e.g., linearly, monotonically) with passage of time to the predetermined first pressure increase acceleration (e.g., from 0 kPa/s to the predetermined maximum pressure increase rate).

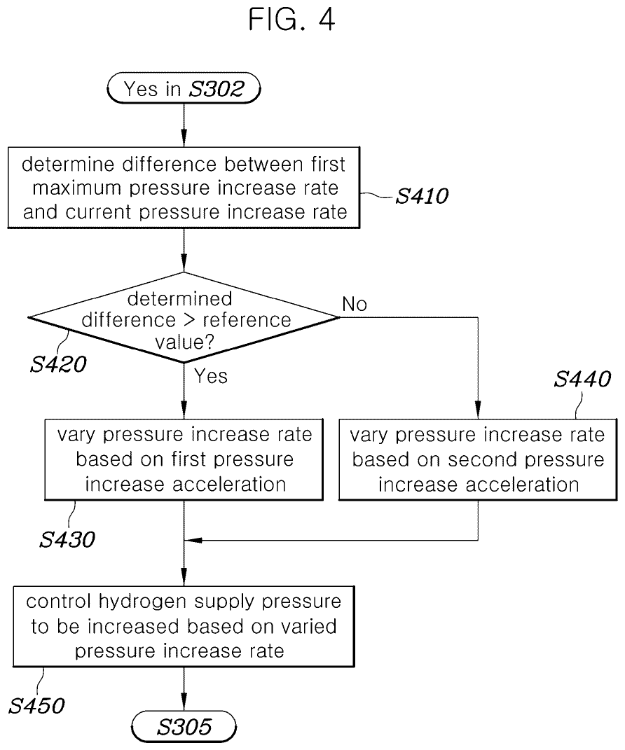

In an example, the controller 300, which varies the pressure increase rate until the pressure increase rate reaches the first maximum pressure increase rate, may gradually vary the pressure increase rate while adjusting the pressure increase acceleration (e.g. varying a rate of varying the pressure increase rate). This will be described with reference to FIG. 4.

FIG. 4 is a flowchart explaining increase control of the hydrogen supply pressure in the controller according to another example of the present disclosure.

For example, referring to FIG. 4, the controller 300 may determine the difference between the first maximum pressure increase rate and the current pressure increase rate (S410). The pressure increase acceleration may be varied based on the determined difference. If the difference is more than a reference value (“Yes” in S420), the controller 300 may (e.g., gradually) vary the pressure increase rate based on the first pressure increase acceleration (e.g., kPa/s²) (S430). In an example, the first pressure increase acceleration is a value set to control the pressure increase rate (e.g., a first rate of change of the pressure increase rate per unit of time corresponds to the first pressure increase acceleration). If the difference is not more than the reference value (“No” in S420), the controller 300 may (e.g., gradually) vary the pressure increase rate based on a second pressure increase acceleration (e.g., kPa/s²) lower than the first pressure increase acceleration (S440). In an example, the second pressure increase acceleration is a value set to control the pressure increase rate (e.g., a second rate of change of the pressure increase rate per unit of time corresponds to the second pressure increase acceleration). The controller 300 may control the hydrogen supply pressure to be increased, based on a pressure increase rate varied based on a selected one of different pressure increase accelerations according to results of the determination in step S420 (S450).

In an example, the controller 300 may gradually vary the pressure increase rate by applying a pressure increase acceleration set to be gradually decreased as the pressure increase rate gradually approaches the first maximum pressure increase rate, until the pressure increase rate reaches the first maximum pressure increase rate. For example, in order to finely vary the pressure increase rate as the pressure increase rate approaches the first maximum pressure increase rate, it may be possible to reduce the variation range of the pressure increase rate by applying a lower pressure increase acceleration as the pressure increase rate approaches the first maximum pressure increase rate. In this case, the period in which the pressure increase rate increases until the pressure increase rate reaches the first maximum pressure increase rate may be divided into a plurality of periods for which different values of the pressure increase acceleration may be applied respectively.

According to the pressure increase acceleration methods disclosed herein, it may be possible to finely (e.g., precisely) perform increase control of the hydrogen supply pressure by finely varying the pressure increase rate.

Referring again to FIG. 3, if the hydrogen supply pressure is not less than the first pressure which is the maximum value of the pressure range (“No” in S302) and/or if the hydrogen supply pressure reaches the first pressure via the above-described increase control of the hydrogen supply pressure, the controller 300 may control the hydrogen supply pressure to be decreased to the second pressure (e.g., the minimum value of the pressure range) based on the predetermined pressure decrease rate (S304). Here, the predetermined pressure decrease rate may refer to a fixed value (e.g., other than a variable value as the above-described pressure increase rate) because the pressure decrease rate does not influence hydrogen recirculation in the anode of the fuel cell stack 100, even when the predetermined pressure decrease rate varies. Of course, this is only illustrative and the present disclosure is not limited thereto. For example, the pressure decrease rate may be varied (e.g., not fixed).

If the hydrogen supply pressure reaches the second pressure (e.g., via decrease control of the hydrogen supply pressure), the controller 300 may control the hydrogen supply pressure to be again increased, to the first pressure, based on the predetermined pressure increase rate. In other words, the controller 300 according to the example of the present disclosure may apply the hydrogen supply pressure (e.g., for continuous supply of hydrogen) in order to induce hydrogen recirculation in the anode of the fuel cell stack 100. The controller 300 may vary the level of the hydrogen supply pressure without applying the hydrogen supply pressure at a constant level such that the hydrogen supply pressure is applied at a higher level or a lower level. Accordingly, it may be possible to effectively induce hydrogen recirculation in the anode of the fuel cell stack 100.

After/based on variation control of the hydrogen supply pressure, as described herein, the controller 300 may determine whether or not a release condition of the control mode is satisfied. For example, the controller 300 may determine whether the release condition of the control mode is satisfied based on at least one of a cell voltage state of the fuel cell stack 100 or an operation state of the fuel cell stack 100. For example, the controller 300 may determine that the release condition of the control mode is not satisfied if the difference between the average cell voltage and the minimum cell voltage of the fuel cell stack 100 (the cell deviation DV) is not less than a predetermined second reference difference value or if the fuel cell stack 100 is (e.g., still) in the idle state (“No” in S305). The predetermined second reference difference value may mean a value set with reference to an average cell voltage deviation and/or determined taking into consideration operation stability of the fuel cell stack 100, similarly to the above-described first reference difference value.

Based on determining that the release condition of the control mode is not satisfied (“No” in S305), the controller 300 may determine whether or not the pressure increase rate, which may be a control factor in increase control of the hydrogen supply pressure, reaches the predetermined first maximum pressure increase rate (S306). If the pressure increase rate does not reach the first maximum pressure increase rate (“No” in S306), the controller 300 may perform variation control of the hydrogen supply pressure (e.g., return to S302) (e.g., the process may proceed again from S302 until the release condition of the control mode is satisfied or until the pressure increase rate reaches the first maximum pressure increase rate).

If the pressure increase rate reaches the first maximum pressure increase rate (“Yes” in S306) (e.g., in a state in which the release condition of the control mode was not satisfied) the controller 300 may change the predetermined first maximum pressure increase rate to a second maximum pressure increase rate having a higher value than that of the first maximum pressure increase rate (S307). The situation in which the release condition of the control mode is not satisfied yet and the pressure increase rate reaches the first maximum pressure increase rate may mean that hydrogen recirculation in the anode of the fuel cell stack 100 is not effectively achieved yet. To this end, it may be necessary/beneficial for the controller 300 to maintain the control mode for hydrogen recirculation (e.g., to continue performing variation control of the hydrogen supply pressure). Accordingly, the controller 300 may change the first maximum pressure increase rate to the second maximum pressure increase rate (e.g., higher than the first maximum pressure increase rate), thereby adjusting the variation range of the level of the hydrogen supply pressure to be widened. Adjusting the variation range of the hydrogen supply pressure may induce hydrogen recirculation.

The controller 300 may control the hydrogen supply pressure to be varied based on a pressure increase rate or a pressure decreased rate reflecting the changed second maximum pressure increase rate (e.g., as described herein) (S308).

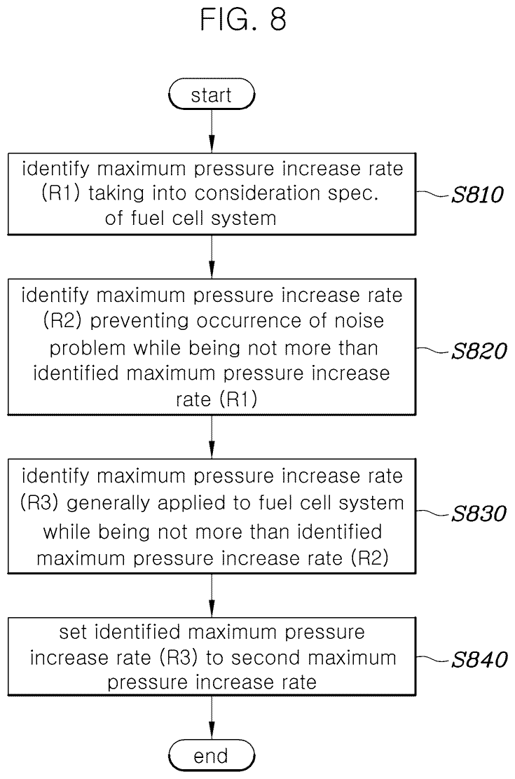

Similarly to the first maximum pressure increase rate, the second maximum pressure increase rate may be previously derived and set through experiments/calibration as disclosed herein. The second maximum pressure increase rate set through experiments/calibration will be described with reference to FIG. 8.

FIG. 8 is a flowchart explaining setting of the second maximum pressure increase rate according to an example of the present disclosure.

A maximum pressure increase rate R1 in the fuel cell system itself may be identified based on specifications of respective constituent elements constituting the fuel cell system (S810). If the pressure increase rate is excessive, noise may be generated in the fuel cell system. Accordingly, it may be necessary to identify a pressure increase rate capable of minimizing/moderating generation of noise (e.g., to an acceptable level) in order to secure marketability of the fuel cell system. To this end, a maximum pressure increase rate R2 preventing occurrence of a noise problem in the fuel cell system itself while being not more than the identified maximum pressure increase rate R1 may be identified (S820).

Thereafter, in order to identify a pressure increase rate applicable while satisfying the above-described two conditions, a maximum pressure increase rate R3 generally applied in the fuel cell system while being not more than the identified maximum pressure increase rate R2 may be identified (S830). For example, the maximum pressure increase rate R3 generally applied in the fuel cell system may mean a pressure increase rate satisfying the start condition of the fuel cell system. Of course, this is only illustrative and the present disclosure is not limited thereto. In addition, the controller 300 may set the identified maximum pressure increase rate R3 to the second maximum pressure increase rate (S840).

Referring again to FIG. 3, the controller 300 may control the hydrogen supply pressure to be varied as described herein, based on the pressure increase rate or the pressure decrease rate reflecting the changed second maximum pressure increase rate (S308). Similarly to steps S303 and S304, as described herein, the controller 300 may control the hydrogen supply pressure to be increased while varying the pressure increase rate based on the pressure increase acceleration, and/or may control the hydrogen supply pressure to be decreased (e.g., based on/at a fixed pressure decrease rate). For example, the controller 300 may gradually vary the pressure increase rate until the pressure increase rate reaches the changed second maximum pressure increase rate (from S307). The controller 300 may gradually vary the pressure increase rate based on a third pressure increase acceleration lower than the pressure increase acceleration applied until the pressure increase rate reaches the first maximum pressure increase rate.

For example, in association with the case described with reference to FIG. 4, the third pressure increase acceleration may be a value lower than that of the first pressure increase acceleration and/or the second pressure increase acceleration. The present disclosure is not limited to the third pressure increase acceleration late being lower than the first and/or second pressure increase accelerations. The controller 300 may control the hydrogen supply pressure to be increased based on the pressure increase rate varied (e.g., gradually) based on the third pressure increase acceleration.

The controller 300 may determine whether or not the current state of the fuel cell stack 100 satisfies the release condition of the control mode (e.g., the cell deviation DV is less than the predetermined second reference difference value or the fuel cell stack 100 is in the idle state) based on the variation control of the hydrogen supply pressure with the second maximum pressure increase rate (e.g., changed from the first maximum pressure increase rate) (S309). In addition to the determination as to whether or not the release condition of the control mode is satisfied (e.g., if the release condition is not satisfied (“No” in S309)), the controller 300 may determine the hydrogen concentration in the anode of the fuel cell stack 100 (S310). For example, during a period in which the hydrogen concentration in the anode of the fuel cell stack 100 is more than a predetermined reference concentration (“Yes” in S310), the controller 300 may repeatedly perform variation control of the hydrogen supply pressure based on the changed second maximum pressure increase rate until the pressure increase rate reaches the second maximum pressure increase rate.

If the current state of the fuel cell stack 100 does not satisfy the release condition of the control mode until the pressure increase rate reaches the changed second maximum pressure increase rate through variation control of the hydrogen supply pressure (“No” in S309) and if the hydrogen concentration in the anode of the fuel cell stack 100 is decreased not to be more than the predetermined reference concentration (“No” in S310), the controller 300 may perform hydrogen purging (S311). If the release condition is not met and the hydrogen concentration is not more than the reference concentration, the controller 300 may determine that hydrogen recirculation in the anode of the fuel cell stack 100 cannot be sufficiently induced through variation control of the hydrogen supply pressure. Accordingly, it may be possible to generate hydrogen recirculation in the anode of the fuel cell stack 100 through forced hydrogen recirculation. For example, in the example of the present disclosure, the controller 300 may perform hydrogen purging (S311) in order to induce forced hydrogen recirculation, but this is only illustrative and the present disclosure is not limited thereto.

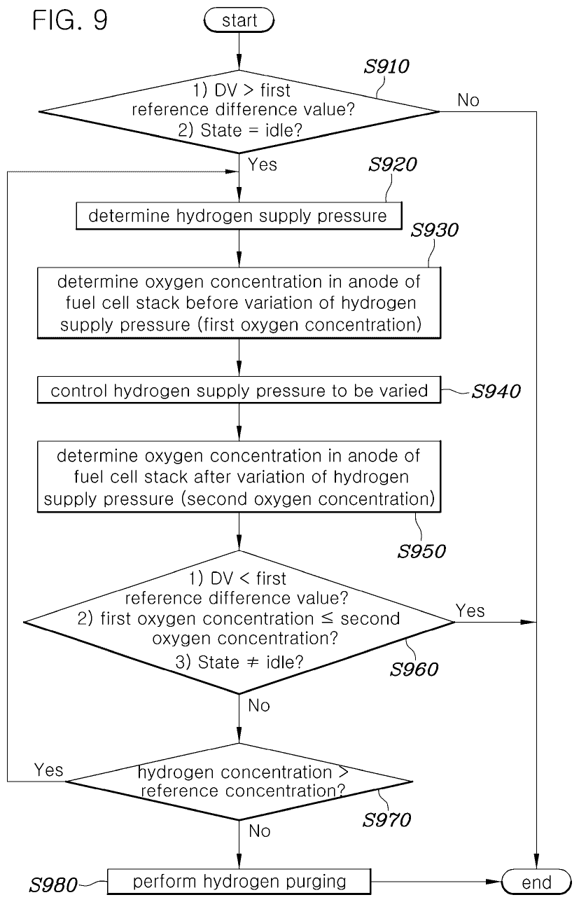

The fuel cell system control method according to the example of the present disclosure described with reference to FIG. 3 may be a control procedure in the case in which it is impossible for the controller 300 to directly sense the oxygen concentration in the anode of the fuel cell stack 100, for control of the fuel cell system. If direct sensing of the oxygen concentration in the anode of the fuel cell stack 100 is possible, the oxygen concentration condition in the anode may be further included for determination as to whether or not the above-described release condition of the control mode is satisfied. Hereinafter, the case in which direct sensing of the oxygen concentration in the anode of the fuel cell stack 100 is possible by the controller 300 in a fuel cell system control method according to another example of the present disclosure will be described with reference to FIG. 9.

FIG. 9 is a flowchart explaining a fuel cell system control method according to another example of the present disclosure in the case in which sensing of oxygen concentration in the anode of the fuel cell stack is possible.

The controller 300 may determine that the control mode for control of the hydrogen supply pressure is required, when the difference between the average cell voltage and the minimum cell voltage of the fuel cell stack 100 (the cell deviation DV) is more than the predetermined first reference difference value or the fuel cell stack 100 is in the idle state (“Yes” in S910), the controller may determine that the control mode for control of the hydrogen supply pressure is required.

Upon determining that the control mode is required, the controller 300 may determine the hydrogen supply pressure currently supplied to the fuel cell stack 100 (S920). In addition, the controller may perform variation control of the hydrogen supply pressure based on the determined hydrogen supply pressure (S940). In this case, steps S920 and S940 may be executed in the same manner as steps S302 to S308 described with reference to FIG. 3. For example, the controller 300 may control the hydrogen supply pressure to be increased to the first pressure which is the maximum value of the predetermined pressure range, based on the predetermined pressure increase rate, when the determined hydrogen supply pressure is less than the first pressure. The controller 300 may control the hydrogen supply pressure to be increased, as in step S303 described above with reference to FIG. 3 or may control the hydrogen supply pressure to be increased, as in steps S410 to S450 described above with reference to FIG. 4.

On the other hand, when the hydrogen supply pressure is not less than the first pressure, the controller 300 may control the hydrogen supply pressure to be decreased to the second pressure which is the minimum value of the pressure range, based on the predetermined pressure decrease rate. The controller 300 may determine whether or not the release condition of the control mode is satisfied, while performing variation control of the hydrogen supply pressure, as in step S940.

If sensing of the oxygen concentration in the anode of the fuel cell stack 100 is possible, the controller 300 may determine the oxygen concentration in the anode of the fuel cell stack 100, and may determine whether or not at least one of the state of the fuel cell stack 100 or a variation in the oxygen concentration in the anode of the fuel cell stack 100 according to (e.g., based on/corresponding to) a variation in the hydrogen supply pressure satisfies the release condition of the control mode (S960).

If direct sensing of the oxygen concentration in the anode of the fuel cell stack 100 is possible, the controller 300 may determine the oxygen concentration in the anode of the fuel cell stack 100 before the variation control of the hydrogen supply pressure (e.g., the increase control or decrease control of the hydrogen supply pressure) (the oxygen concentration sensed before the variation control being referred to as a “first oxygen concentration” hereinafter) (S930).

The controller 300 may determine an oxygen concentration in the anode of the fuel cell stack 100 after/during/based on the variation control of the hydrogen supply pressure (the oxygen concentration determined after/during/based on the variation control being referred to as a “second oxygen concentration” hereinafter) (S950). The controller 300 may determine whether or not the release condition of the control mode is satisfied based on whether or not the difference between the average cell voltage and the minimum cell voltage (the cell deviation DV) is less than the predetermined second reference difference value, whether or not the fuel cell stack 100 is in the idle state, and/or whether or not the first oxygen concentration sensed before the variation control of the hydrogen supply pressure is not more than the second oxygen concentration sensed after the variation control of the hydrogen supply pressure (S960).

For example, the controller 300 may determine that the state of the fuel cell stack 100 satisfies the release condition of the control mode if the difference between the average cell voltage and the minimum cell voltage (the cell deviation DV) is less than the predetermined second reference difference value or the fuel cell stack 100 is not in the idle state, and may determine that the oxygen concentration in the anode of the fuel cell stack 100 satisfies the release condition of the control mode if the first oxygen concentration is not more than the second oxygen concentration (“Yes” in S960). In another example, assuming that the variation control of the hydrogen supply pressure according to the example of the present disclosure is performed in the idle state of the fuel cell stack 100, the controller 300 may determine whether or not the fuel cell stack 100 is in the idle state, and may then determine that the release condition of the control mode is satisfied based on the fuel cell stack 100 not being in the idle state, without separately considering/determining the cell deviation and/or the variation in oxygen concentration. If the fuel cell stack 100 is still in the idle state, the controller 300 may determine that the release condition of the control mode is satisfied, under the condition that the cell deviation is less than the predetermined second reference difference value and the first oxygen concentration is not more than the second oxygen concentration. The examples discussed herein are only illustrative and the present disclosure is not limited thereto.

The controller 300 may determine that the release condition of the control mode is satisfied if both the state of the fuel cell stack 100 and the variation in the oxygen concentration in the anode of the fuel cell stack 100 satisfy the release condition of the control mode (either (1) or (3) in S960 are Yes and (2) in S960 is Yes).

If the state of the fuel cell stack 100 and/or the variation in the oxygen concentration in the anode of the fuel cell stack 100 do not satisfy the release condition of the control mode (“No” in S960), the controller 300 may perform variation control of the hydrogen supply pressure until the release condition of the control mode is satisfied. The controller 300 may initially fix the maximum pressure increase rate to the second maximum pressure increase rate, and may then control the hydrogen supply pressure to be increased, while (e.g., gradually) varying the pressure increase rate until the pressure increase rate reaches the above-described second maximum pressure increase rate, differently from the case in which the maximum pressure increase rate is changed from the first maximum pressure increase rate to the second maximum pressure increase rate, as described with reference to FIG. 3. The decrease control of the hydrogen supply pressure based on the pressure decrease rate may be performed in the same manner as step S304 described with reference to FIG. 3.

If the state of the fuel cell stack 100 and the oxygen concentration variation in the anode of the fuel cell stack 100 do not satisfy the release condition of the control mode (“No” in S960), the controller 300 may determine the hydrogen concentration in the anode of the fuel cell stack 100 (S970), and/or may perform the variation control of the hydrogen supply pressure until the hydrogen concentration in the anode is not more than the predetermined reference concentration.

If the state of the fuel cell stack 100 and the oxygen concentration variation in the anode of the fuel cell stack 100 do not satisfy the release condition of the control mode until the pressure increase rate reaches the second maximum pressure increase rate (“No” in S960), and the hydrogen concentration in the anode of the fuel cell stack 100 is not more than the predetermined reference concentration (“No” in S970), the controller 300 may perform hydrogen purging (S980). The hydrogen purging may be performed in the same manner as step S311 described with reference to FIG. 3.

As apparent from the present description, the fuel cell system and the control method thereof according to the present disclosure may induce recirculation of hydrogen in the anode of the fuel cell stack when a hydrogen concentration deviation is generated in the anode of the fuel cell stack, by controlling the hydrogen supply pressure based on the pressure increase rate or the pressure decrease rate.

Also, or alternatively, as recirculation of hydrogen is induced through control of the hydrogen supply pressure based on the pressure increase rate or the pressure decrease rate, it may be possible to prevent oxygen from being accumulated or introduced in the anode of the fuel cell stack.

Furthermore, as accumulation or introduction of oxygen in the anode of the fuel cell stack is prevented, it may be possible to prevent degradation of the electrodes and the electrolyte membrane of the fuel cell stack and to enhance the durability performance of the fuel cell stack. Accordingly, an expected lifespan of the fuel cell stack may be enhanced.

Although the examples of the present disclosure have been disclosed for illustrative purposes, those skilled in the art will appreciate that various modifications, additions and substitutions are possible without departing from the scope and spirit of the disclosure as disclosed herein and in the accompanying claims.

Furthermore, the term related to a control device such as “controller” (e.g., controller 300), “control apparatus”, “control unit”, “control device”, “control module”, or “server”, etc., refers to a hardware device including a memory and a processor configured to execute one or more steps interpreted as an algorithm structure. The memory stores algorithm steps, and the processor executes the algorithm steps to perform one or more processes of a method in accordance with various examples of the present disclosure. The control device according to examples of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various examples of the present disclosure.

The aforementioned disclosure can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc., and implementation as carrier waves (e.g., transmission over the Internet). Examples of the program instruction include machine language code such as those generated by a compiler, as well as high-level language code which may be executed by a computer using an interpreter or the like.

In various examples of the present disclosure, each operation described above may be performed by a control device (e.g., controller 300), and the control device may be configured by a plurality of control devices, or an integrated single control device.

In various examples of the present disclosure, the memory and the processor may be provided as one chip, or provided as separate chips.

In various examples of the present disclosure, the scope of the present disclosure includes software or machine-executable commands (e.g., an operating system, an application, firmware, a program, etc.) for enabling operations according to the methods of various examples to be executed on an apparatus or a computer, a non-transitory computer-readable medium including such software or commands stored thereon and executable on the apparatus or the computer.

In various examples of the present disclosure, the control device may be implemented in a form of hardware or software, or may be implemented in a combination of hardware and software.

Therefore, the present disclosure has been made in view of the above problems, and it is an object of the present disclosure to provide a fuel cell system and a method of controlling the same which are capable of inducting recirculation of hydrogen gas in an anode of a fuel cell stack through adjustment of a hydrogen supply pressure applied to the fuel cell stack without requirement of a separate operation or separate hardware.

Objects of the present disclosure are not limited to the above-described objects, and other objects of the present disclosure not yet described will be more clearly understood by those skilled in the art from the following detailed description.

In accordance with an aspect of the present disclosure, the above and other objects can be accomplished by the provision of a fuel cell system including a hydrogen pressure adjuster configured to adjust a hydrogen supply pressure of hydrogen supplied to a fuel cell stack, and a controller configured to determine whether or not a control mode for controlling the hydrogen supply pressure is required, based on a state of the fuel cell stack, and to control the hydrogen pressure adjuster to vary the hydrogen supply pressure in a predetermined pressure range based on a pressure increase rate or a pressure decrease rate, when the control mode is required.

In accordance with another aspect of the present disclosure, there is provided a method of controlling a fuel cell system, including determining whether or not a control mode for controlling a hydrogen supply pressure supplied to the fuel cell stack is required, based on a state of the fuel cell stack, and controlling the hydrogen supply pressure to be varied in a predetermined pressure range based on a pressure increase rate or a pressure decrease rate, upon determining that the control mode is required.

In accordance with the present disclosure as described above, the fuel cell system and the control method thereof according to the present disclosure may induce recirculation of hydrogen in the anode of the fuel cell stack when a hydrogen concentration deviation is generated in the anode of the fuel cell stack, by controlling the hydrogen supply pressure based on the pressure increase rate or the pressure decrease rate.

In addition, as recirculation of hydrogen is induced through control of the hydrogen supply pressure based on the pressure increase rate or the pressure decrease rate, it may be possible to prevent oxygen from being accumulated or introduced in the anode of the fuel cell stack.

Furthermore, as accumulation or introduction of oxygen in the anode of the fuel cell stack is prevented, it may be possible to prevent degradation of the electrodes and the electrolyte membrane of the fuel cell stack and to enhance the durability performance of the fuel cell stack. Accordingly, an expected lifespan of the fuel cell stack may be enhanced.

Effects attainable in the present disclosure are not limited to the above-described effects, and other effects of the present disclosure not yet described will be more clearly understood by those skilled in the art from the following detailed description.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the examples with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In examples of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the example of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific examples of the present disclosure have been presented for purposes of illustration and description. They are not intended to be exhaustive or to limit the present disclosure to the precise forms disclosed, and obviously many modifications and variations are possible in light of the above teachings. The examples were chosen and described in order to explain certain principles of the disclosure and their practical application, to enable others skilled in the art to make and utilize various examples of the present disclosure, as well as various alternatives and modifications thereof. It is intended that the scope of the present disclosure be defined by the Claims appended hereto and their equivalents.

What is claimed is:

1. A fuel cell system comprising:
a hydrogen pressure adjuster configured to adjust a hydrogen supply pressure of hydrogen supplied to a fuel cell stack; and
a controller configured to:
determine that a state of the fuel cell stack comprises:
a cell voltage deviation of the fuel cell stack satisfies a threshold, or
the fuel cell stack is idle; and
based on the state of the fuel cell stack, control the hydrogen pressure adjuster to vary, based on a pressure increase rate or a pressure decrease rate, the hydrogen supply pressure within a pressure range.

2. The fuel cell system of claim 1, wherein the cell voltage deviation is based on a difference between an average cell voltage and a minimum cell voltage of the fuel cell stack, and wherein the cell voltage deviation satisfies the threshold based on the difference being greater than a first reference difference value.

3. The fuel cell system of claim 1, wherein a first pressure is a maximum pressure of the pressure range and a second pressure is a minimum pressure of the pressure range;
wherein the controller is configured to:
control, based on the hydrogen supply pressure being lower than the first pressure, the hydrogen pressure adjuster to increase, at the pressure increase rate, the hydrogen supply pressure to the first pressure; or
control, based on the hydrogen supply pressure being equal to or greater than the first pressure, the hydrogen pressure adjuster to decrease, at the pressure decrease rate, the hydrogen supply pressure to the second pressure.

4. The fuel cell system of claim 3, wherein the pressure increase rate is a variable pressure increase rate that varies gradually from an initial pressure increase rate to a first maximum pressure increase rate.

5. The fuel cell system of claim 4, wherein the controller is configured to gradually vary the pressure increase rate based on a first pressure increase acceleration.

6. The fuel cell system of claim 4, wherein the controller is configured to:
gradually vary the pressure increase rate based on a first pressure increase acceleration and based on a difference between the first maximum pressure increase rate and the pressure increase rate being greater than a reference value, or
gradually vary the pressure increase rate based on a second pressure increase acceleration lower than the first pressure increase acceleration and based on the difference between the first maximum pressure increase rate and the pressure increase rate is not greater than the reference value.

7. The fuel cell system of claim 4, wherein the controller is configured to:
gradually vary the pressure increase rate, to the first maximum pressure increase rate, at a pressure increase acceleration that gradually decreases as the pressure increase rate approaches the first maximum pressure increase rate.

8. The fuel cell system of claim 1, wherein the controller is configured to control the hydrogen pressure adjuster to vary the hydrogen supply pressure until the state of the fuel cell stack is determined to satisfy a release condition in which:
the cell voltage deviation does not satisfy the threshold; or
the fuel cell stack is not idle.

9. The fuel cell system of claim 8, wherein the controller is configured to determine that the release condition is satisfied based on a difference between an average cell voltage and a minimum cell voltage of the fuel cell stack is less than a second reference difference value and based on the fuel cell stack not being idle.

10. The fuel cell system of claim 8, wherein the controller is configured to:
control the hydrogen pressure adjuster to vary the hydrogen supply pressure based on a pressure increase rate that increases to a first maximum pressure increase rate; and
based on determining that the release condition is not satisfied and based on determining that the pressure increase rate has reached the first maximum pressure increase rate:
increase the first maximum pressure increase rate to a second maximum pressure increase rate; and
control the hydrogen pressure adjuster to vary the hydrogen supply pressure based on the second maximum pressure increase rate.

11. The fuel cell system of claim 10, wherein the controller is configured to:
gradually vary the pressure increase rate, at a lower pressure increase rate acceleration than a pressure increase rate acceleration used in increasing the pressure increase rate to the first maximum pressure increase rate, until the pressure increase rate reaches the second maximum pressure increase rate.

12. The fuel cell system of claim 10, wherein the controller is configured to:
determine whether or not the state of the fuel cell stack satisfies the release condition during control of the hydrogen pressure adjuster to vary the hydrogen supply pressure based on the second maximum pressure increase rate; and
enable hydrogen purging based on one or more of:
the state of the fuel cell stack not satisfying the release condition, or a hydrogen concentration in an anode of the fuel cell stack not being greater than a reference concentration until the pressure increase rate reaches the second maximum pressure increase rate.

13. The fuel cell system of claim 8, wherein the controller is further configured to:
determine an oxygen concentration in an anode of the fuel cell stack, wherein the release condition further comprises a variation in the oxygen concentration, based on variation of the hydrogen supply pressure, satisfying an oxygen release condition.

14. The fuel cell system of claim 13, wherein the release condition is satisfied based on:
a difference between an average cell voltage and a minimum cell voltage of the fuel cell stack being less than a second reference difference value or the fuel cell stack not being idle; and
a first oxygen concentration sensed before variation of the hydrogen supply pressure not being greater a second oxygen concentration sensed after the variation of the hydrogen supply pressure.

15. The fuel cell system of claim 13, wherein the controller is configured to control the hydrogen pressure adjuster to vary the hydrogen supply pressure by gradually varying the pressure increase rate until the pressure increase rate reaches a second maximum pressure increase rate.

16. A method of controlling a fuel cell system, the method comprising:
determining that a state of a fuel cell stack of the fuel cell system comprises:
a cell voltage deviation of the fuel cell stack satisfies a threshold; or
the fuel cell stack is idle; and
based on the determined state of the fuel cell stack, controlling a hydrogen supply pressure, to an anode of the fuel cell stack, to be varied, based on a pressure increase rate or a pressure decrease rate, within a pressure range.

17. The method of claim 16, wherein a first pressure is a maximum pressure of the pressure range and a second pressure is a minimum pressure of the pressure range, and wherein the controlling comprises one or more of:
controlling, based on the hydrogen supply pressure being lower than the first pressure, the hydrogen supply pressure to be increased, at the pressure increase rate, to the first pressure; or
controlling, based on the hydrogen supply pressure not being lower than the first pressure, the hydrogen supply pressure to be decreased, at the pressure decrease rate, to the second pressure.

18. The method of claim 16, wherein the controlling the hydrogen supply pressure to be varied is continued until the state of the fuel cell stack satisfies a release condition in which:
the cell voltage deviation does not satisfy the threshold; and
the fuel cell stack is not idle.

19. The method of claim 18, wherein the controlling the hydrogen supply pressure to be varied comprises varying the hydrogen supply pressure at the pressure increase rate, wherein the pressure increase rate is increased to reach a first maximum pressure increase rate, and wherein the method further comprises:
based on determining that the state of the fuel cell stack does not satisfy the release condition after the pressure increase rate reaches the first maximum pressure increase rate, increasing the first maximum pressure increase rate to a second maximum pressure increase rate; and
controlling the hydrogen supply pressure to be varied based on the second maximum pressure increase rate.

20. A fuel cell system comprising:
a fuel cell stack;
a hydrogen pressure sensor configured to sense a hydrogen supply pressure of hydrogen supplied to the fuel cell stack; and
a controller comprising at least one processor and at least one memory,
wherein the controller is configured to:
determine that a hydrogen pressure control condition associated with the fuel cell stack is satisfied, wherein the hydrogen pressure control condition comprises a cell voltage deviation of the fuel cell stack satisfying a threshold, and
based on the hydrogen pressure control condition being satisfied, control the hydrogen supply pressure to be varied, based on a pressure increase rate or a pressure decrease rate, within a pressure range.
